(19) United States
(12) Patent Application Publication
(10) Pub. No.: US 2014/0258348 A1
(43) Pub. Date: Sep. 11, 2014

(54) METHODS AND SYSTEMS FOR ASSOCIATION OF E-BOOK AND MULTIMEDIA CONTENT

(71) Applicant: Usman Hafeez, Chicago, IL (US)

(72) Inventor: Usman Hafeez, Chicago, IL (US)

(21) Appl. No.: 13/788,382

(22) Filed: Mar. 7, 2013

(51) Int. Cl. G06F 17/30

(52) U.S. Cl. CPC G06F 17/30194
USPC 707/827

(57) ABSTRACT

The present invention discloses methods and systems to allow association of selected E-book content with multimedia content, such as video content on one device. The files for the E-book and the multimedia content can reside either on the device or reside remotely. The invention includes the sharing and distribution of the selected E-book content and multimedia content association so that other users having the same E-book may find associated multimedia content when viewing their E-book.

### RELATED APPLICATIONS

This application claims the benefit under 35 U.S.C. §119(e) of U.S. Provisional Application No. 61/641,151 filed on 1 May 2012 entitled “Methods and Systems for Association of E-book and Multimedia Content” which is herein incorporated by reference.

### FIELD OF THE INVENTION

This invention is related generally to the field of information management. This invention is related more particularly to methods and systems for association of E-book and multimedia content to facilitate ease of understanding and studying and sharing of the associated materials.

### BACKGROUND OF THE INVENTION

With the development of the Internet and digital technologies, the E-book has been developed as an alternative to printed books. The use of E-books has advantages including drastically reducing space required for a collection of books, reduced costs for the E-books as compared to hardcover or paperback printed books and allowing for easy transport of books. This is particularly desirable for college students who previously had to transport an “armload” of textbooks to classes. Currently, college students frequently purchase multiple text books for a full time class load. Frequently, these students pay inflated prices, have few purchase options, and are forced to carry heavily loaded book bags containing not only their textbooks, but all the associated material needed for class, such as class notes, notebooks, highlighters, etc. All of this is a burden to the students, and costs the average college student quite a lot every semester. In addition, students may need to take copious notes while in class based on their professors' lectures, which distracts their attention from listening to and learning the material the professor is attempting to teach. This note taking places the emphasis and effort in capturing what the professor says, writes, or displays to the class, instead of listening to and learning the material the professor is attempting to teach. In addition, there is no way for students to accurately share what the professor said during a lecture with a student that may have missed that lecture, nor for the student to go reference the lecture when studying for an exam other than by recalling what was said and referencing the notes taken.

E-books (read on tablet computer, smart phone, laptop, television or other electronic devices that allows an electronic reader to read an E-book) have begun to be more widely used as a replacement for traditional printed books. E-book or E-textbook technology allows the user (let's say, a student) to find and purchase their books online, and download the book to the associated book reader or read the textbook on the ‘cloud’ through a browser.

The use of E-books also allows the capability of linking other related multimedia content such as video, audio, images, written comments or even 3-D files to the content of the E-book. Often there is considerable multimedia content related to the E-book available online, or available through other sources, but an E-book reader may not be aware of this related multimedia content. Therefore, linking of multimedia content related to an E-book to specific E-book content is desirable. However, attempts to do this in the prior art has been limited. U.S. Pub. No. 2011/0106970 to Song et al, teaches synchronization of E-book and video content. This synchronization is primarily for two separate devices, but it can be for one device as well. This invention, however, appears to lack any significant functionality with regards to how the E-book content relates to video content. This invention also lacks an explanation of how the E-book and video content association may be shared, so that the association may be expanded to multiple devices and also may reside only on a single device.

U.S. Pat. No. 7,849,393 to Hendricks et al. teaches linking of E-book and video content, primarily in Sections VIII and IX of the “detailed disclosure” section. This invention appears to be focused, in regards to E-books and multimedia content, to the hyper-linking of the two files types in one or more hidden tables in an E-book, or a collection of E-books and not with a method of association that beyond the listing of hyper-links. This linking of E-books and multimedia includes the use of World Watch Live, a Discovery service.

U.S. Pub. No. 2011/0207107 to Cancilliari et al. teaches a method for providing and accessing E-textbooks including additional “customized content” beyond the material in the E-textbook to create a customized E-textbook. This customized content, for instance, may be provided by teachers utilizing the E-textbook for their classroom. This customized content in the customized E-textbook may be for students of varied learning capacities or for a specific student. This customized content in the customized E-textbook may be teachers own lesson plans which may be uploaded by students. This publication does not teach a method of associating a portion of an E-textbook with a portion or all of a video and have that association also be sharable with other users.

U.S. Pat. No. 7,877,460 to Brouwer et al. shows methods and systems for facilitating the distribution, sharing and commentary of E-books, particularly E-textbooks. The focus of the Brouwer patent is primarily in the sharing of content related to E-textbooks in real time with multiple “layers” of information embedded in notes. Users of the E-textbooks in this system may access the information by clicking on an icon in the E-textbooks. One layer of notes may be for the author, another layer may be for teachers, or professor utilizing an E-textbook in a class and additional layers may be utilized by students or others on the Internet to post comments. U.S. Pat. No. 7,877,460 does not teach methods and systems which allow a user to record video and audio portions of a lecture and then associate certain content of the user's E-textbook to a certain portion or all of that recorded lecture. U.S. Pat. No. 7,877,460 also does not teach the ability to source a video which relates to material in the e-book and create an association which can then be shared with anyone, not just limited to people within a certain group or within a class. Also, in U.S. Pat. No. 7,877,460, the content always remains on servers and hence, does not reside or originate from a local device. Further, U.S. Pat. No. 7,877,460 involves the conversion of various eBook file formats (such as PDF, ePub, etc.) into an XML format in order to allow for data content association. This conversion is cumbersome. U.S. Pat. No. 7,877,460 references “layers” which are associated, have grouped content displayed or are hidden to a user or groups of users based on access rights. The use of layers may also be cumbersome.

From the above, it is apparent that a deficiency exists in the prior art for associating E-book, or E-textbook content, including specific sentences, paragraphs, pages, or chapters to multimedia content including video, audio, images and 3-D renderings. This deficiency in the art includes the lack of ability to share the E-book content and multimedia content with others. In the case of an E-textbook, the multimedia association could include a video of a professor's lecture that explains material covered in the E-textbook, or a picture of the blackboard/whiteboard explaining a concept covered in the E-textbook, or content found online that better explains concepts covered in the E-textbook. Therefore, there is a need in the art which allows the association of the file types, and in particular, a particular location of an E-book with a particular portion of a multimedia file with the use of tagging, which can either be done systemically or manually, or a combination of the two.

### SUMMARY OF THE INVENTION

A method and system for associating E-book content with multimedia content and sharing the associated E-book content and multimedia content. The method includes logging into a server from a first device, opening an E-book file containing content on the first device, electronically selecting a portion of the content in the E-book file on the first device, electronically associating the selected content with multimedia content and uploading the location of the associated selected content and multimedia content to a server.

A file containing the associated selected content and multimedia content on the first device uploaded to the server may then be opened on a second device.

The method and system for associating E-book content with multimedia content and sharing the associated E-book content and multimedia content may further include having the E-book content and multimedia content reside on a device. Or one of the E-book content and multimedia content may reside outside the device. Or both of the E-book content and multimedia content may reside outside the device.

In another embodiment the multimedia content associated with the selected E-book content is identified by an icon displayed on the first device. The icon is unique to the type of multimedia content being associated.

In a further embodiment a file containing the associated electronically selected E-book content and multimedia content on a first device is capable of being shared to another device through one of Near Field Communication, Bluetooth, or an app which resides on one of or both of the first device and the other device. This wireless technology allows the transferring of data containing the location of the associated selected content and multimedia content from the first device to another device by touching the first device to the other device or by locating the first device in close proximity to the other device.

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, in which:

FIG. 1A illustrates a diagrammatic view of a system overview utilizing a network such as the Internet in accordance with the inventive concept to save and share the location of the associated selected content and multimedia content through the use of a remote server.

FIG. 1B illustrates a diagrammatic view of a system overview utilizing a form of close proximity communication in accordance with the inventive concept to save and share the location of the associated selected content and multimedia content without relying on a remote server.

FIG. 2 illustrates a block diagram illustrating methods of associating multimedia content and E-book content where both the multimedia and e-book content is on the same device in accordance with the inventive concept.

FIG. 3 illustrates a block diagram illustrating methods of associating multimedia content and E-book content where one of the multimedia and e-book content is on the device and the other residing outside the device in accordance with the inventive concept.

FIG. 4 illustrates a block diagram illustrating methods of associating multimedia content and E-book content where both the multimedia and e-book content resides outside the device in accordance with the inventive concept.

FIG. 5 illustrates a block diagram illustrating the interrelationship of and content flow between various users to the system in accordance with the inventive concept.

FIG. 6 illustrates a diagrammatic view of the recording of multimedia content in accordance with the inventive concept.

FIG. 7 illustrates a diagrammatic view illustrating the association of multimedia content to E-book content in accordance with the inventive concept.

FIG. 8 illustrates the association to E-book content and multimedia content sourced from a source outside of the device, such as the Internet, in accordance with the inventive concept.

FIG. 9 illustrates the sharing of association information of multimedia content to E-book content from the server to a second device in accordance with the inventive concept.

FIG. 10 is a diagrammatic view illustrating the sharing of association information of multimedia content to E-book content between two devices without the need of an Internet connection or connection to a remote server through the use of Near Field Communication (NFC), Bluetooth, an app or a similar method of close proximity communication where the devices are in close proximity to each other in accordance with the inventive concept.

### DETAILED DESCRIPTION OF REPRESENTATIVE EMBODIMENTS

The following description is merely exemplary in nature and is not intended to limit the present disclosure, application, or uses. Specific details such as detailed configurations and components are merely provided to assist the overall understanding of exemplary embodiments. It should be apparent to those skilled in the art that various changes and modifications of the exemplary embodiments described herein can be made without departing from the scope and spirit of the invention. In addition, descriptions of well-known functions and constructions, such as the internet and cloud computing, are omitted for clarity and conciseness.

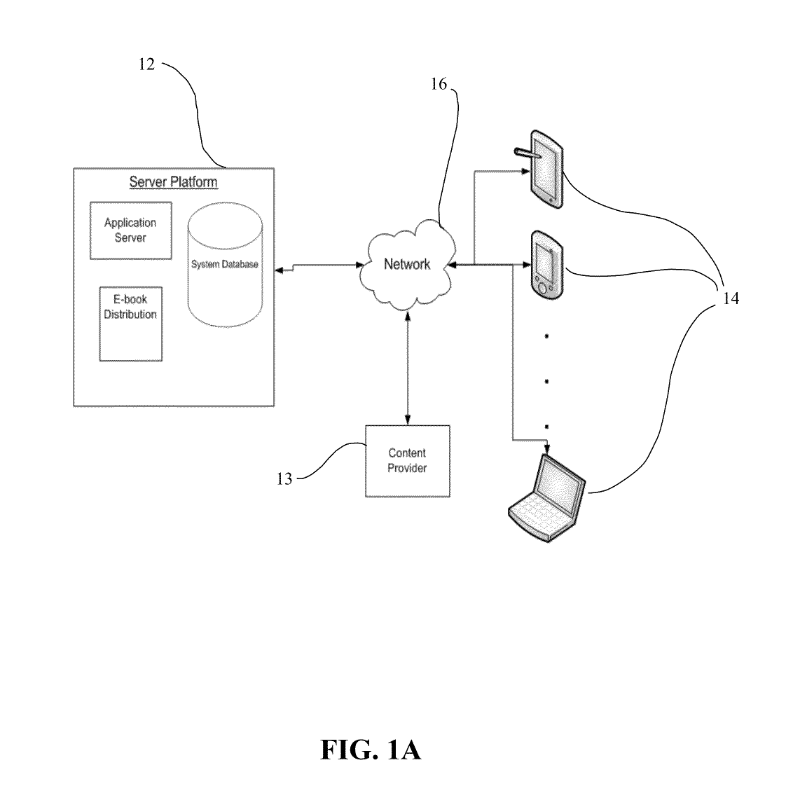

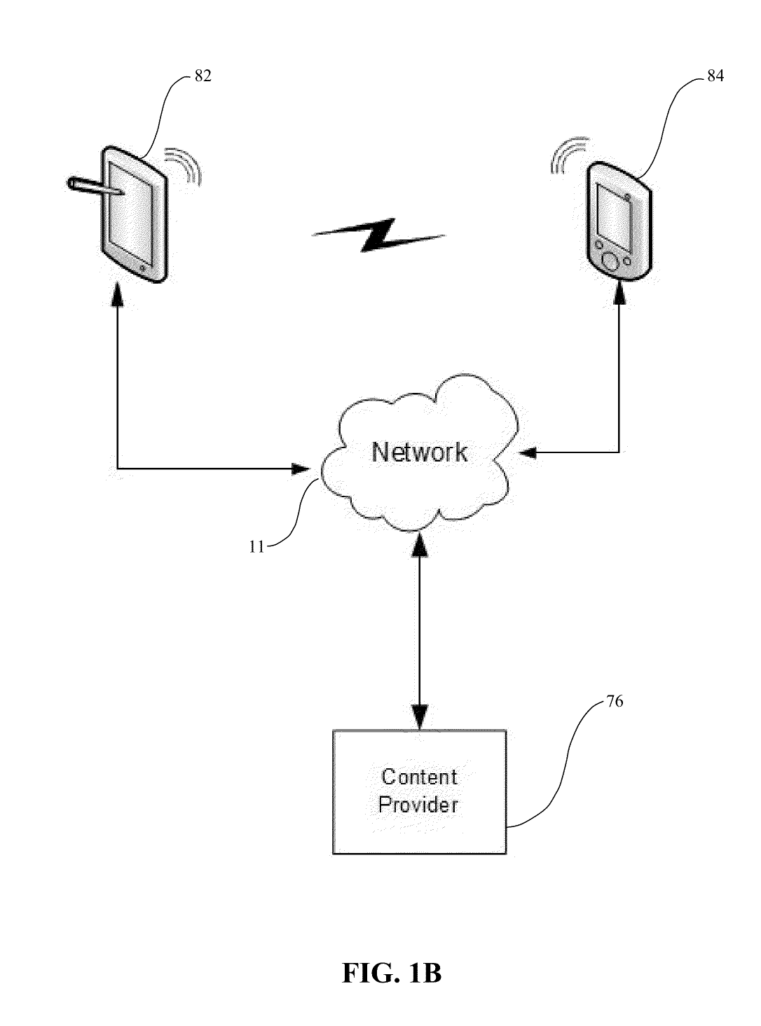

FIG. 1A illustrates an overall diagrammatic view of the system 10 in accordance with the inventive concept. As illustrated in FIG. 1A, a server platform 12 is in communication with multiple devices 14 via a network such as the Internet 16 in accordance with an inventive concept. The server platform 12 may function as an application server and a communication and storage server. As illustrated on FIG. 1A, the multiple devices 14 may be a desktop computer, a laptop computer, a tablet or a smartphone, but the inventive concept is not limited to these devices. The server platform 12 may also distribute E-books to a user via a network, where the network is the Internet 16. A content provider 13, such as other web site servers also interfaces with the server platform 12 and multiple devices 14 through the Internet 16.

FIG. 1B illustrates an overall diagrammatic view of a system 10 utilizing a network such as the Internet and communication between the devices not requiring a network in accordance with another inventive concept. As illustrated in FIG. 1B, a first mobile device 82 is in communication with a second mobile device 84 in accordance with the inventive concept. As also illustrated in FIG. 1B, the first mobile device 82 and the second mobile device 84 are in communication with each other via close proximity communication such as through the use of Near Field Communication (NFC), Bluetooth, or a similar method of communication where the devices are in close proximity to each other. The first 82 and second 84 mobile devices may be a smart phone, or tablet, or laptop but the invention is not limited to these devices. The first 82 and second 84 mobile devices can be in communication with a content provider 76 through the network 11. As illustrated on FIG. 1B, the first 82 and second 84 mobile devices may have the capability of communicating with each other directly and without out the need for the network 11 to communicate.

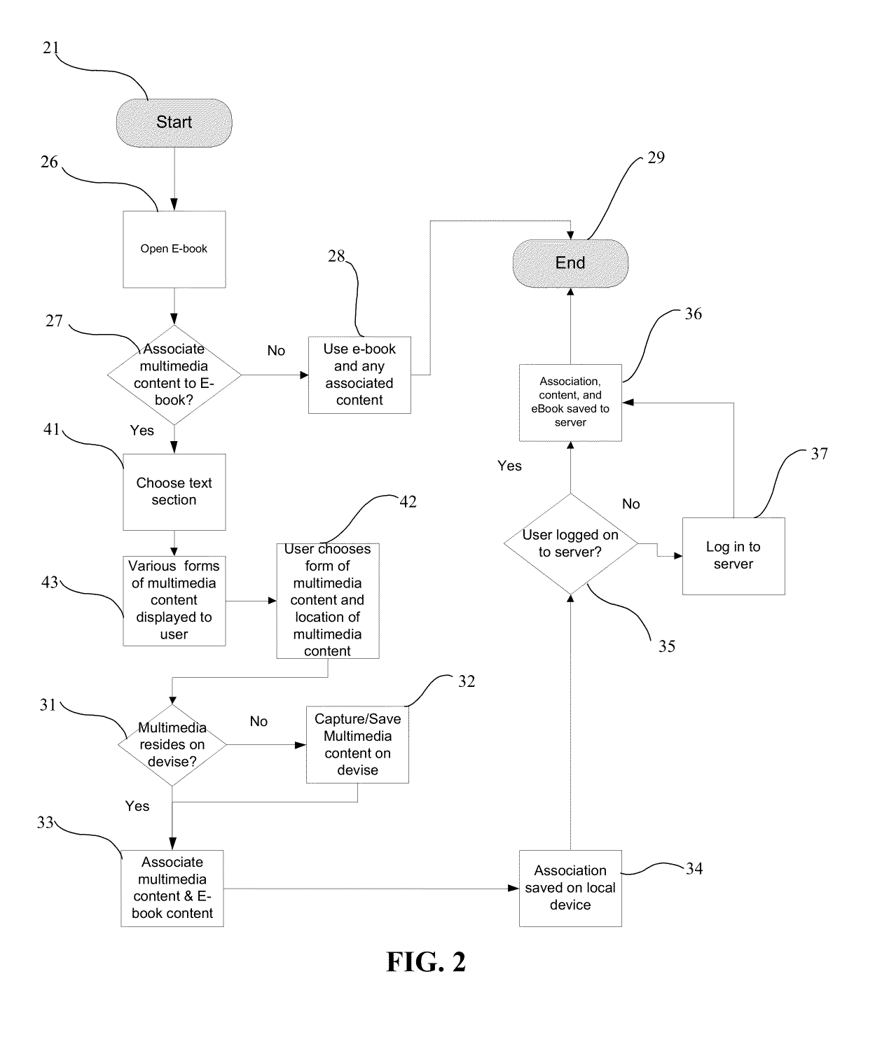

FIG. 2 illustrates a block diagram illustrating steps of a method 20 of associating multimedia content and E-book content where both the multimedia and E-book content is on the same device in accordance with the inventive concept. As illustrated on FIG. 2, a user starts the method in step 21. In step 26, the user opens the E-book. After step 26, the user proceeds to decision step 27 where a user is given a choice of whether or not to associate multimedia content, such as a video, to E-book content. If the answer to decision step 27 is “NO”, the user proceeds to step 28 in which the user uses the E-book and any associated content. After step 28, the user proceeds to the end of the method in step 29. If the answer to decision step 27 is “YES”, the user then proceeds to step 41 where a text section of interest is chosen. After step 41, the user then proceeds to step 42 where various forms of multimedia content is displayed to the user. After step 42, the user then proceeds to step 43 where the user chooses the form of multimedia content and the location of the multimedia content. After step 43, the user proceeds to decision step 31 where it is decided whether or not the multimedia content has been recorded or capture on the devise, where the multimedia content being associated can be a video, image, audio, or any other form of multimedia that can be recorded, captured, or made on the devise. If the answer to decision step 31 is “NO”, the user proceeds to step 32 in which the user captures, records, or makes the multimedia content, such as recording a video, and then proceeds to step 33 as described below. If the answer to decision step 31 is “YES”, the user proceeds to step 33 where multimedia content and E-book content is associated. The user then proceeds to step 34 where the multimedia content and E-book content association of step 33 is saved on a local device. The user then proceeds to decision step 35 in which the user decides whether, or not he is logged into the server 12 for the system platform (FIG. 1). If the answer to decision step 35 is “NO”, the user proceeds to step 37 in which the user logs into the server 12. After step 37, the user proceeds to step 36 described below. If the answer to decision step 35 is “YES”, the user then proceeds to proceeds to step 36 where the multimedia content to E-book content association of step 33 as well as the entire E-book is saved on the server 12 for the system platform. In the case of where an entire E-book for which an association to multimedia content is being made already resides on the server 12, only the E-book and multimedia content and not the entire E-book is saved to the server 12. After step 36 the user then proceeds to the end of method step 29.

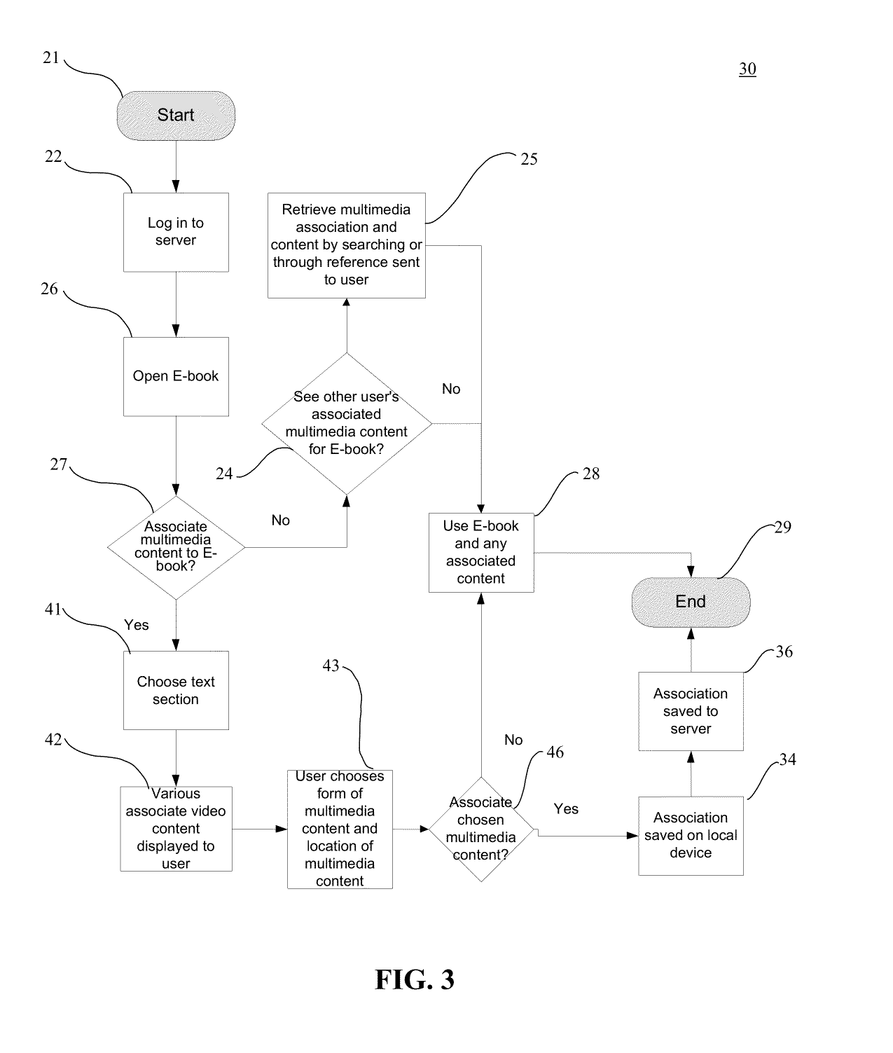

FIG. 3 illustrates a block diagram illustrating a method 30 of associating multimedia content and E-book content where one of the multimedia and E-book content is on the device and the other residing outside the device in accordance with the inventive concept. Note that where the steps in FIG. 3 are the same as in FIG. 2, the same step numbers are used. As illustrated on FIG. 3, a user starts the method in step 21. In step 22, the user logs into the server 12 (FIG. 1) for the system platform. The user then proceeds to step 26, where the user opens the E-book. After step 26, the user proceeds to decision step 27 where a user is given a choice of whether or not to associate multimedia content, such as a video, to E-book content. If the answer to decision step 27 is “NO”, the user proceeds to decision step 24 where a user is given a choice of whether or not to see other users associated multimedia content for the same E-book. If the answer to decision step 24 is “NO”, the user proceeds to step 28 in which the user uses the E-book and any associated content. After step 28, the user proceeds to the end of the method in step 29. If the answer to decision step 24 is “YES”, the user then proceeds to step 25 in which the user retrieves multimedia association and content by searching for multimedia content or by through a reference sent to the user. After step 25, the user then proceeds to step 28 in which the user uses the E-book and any associated content. After step 28, the user proceeds to the end of the method in step 29. If the answer to decision step 27 is “YES”, the user then proceeds to step 41 where a text section of interest is chosen. After step 41, the user then proceeds to step 42 where various forms of multimedia content is displayed to the user. After step 42, the user then proceeds to step 43 where the user chooses the form of multimedia content and the location of the multimedia content. After step 43, the user proceeds to decision step 46 where it is decided whether, or not to associate the multimedia content to the chosen E-book content. If the answer to decision step 46 is “NO”, the user proceeds to step 28 in which the user uses the E-book and any associated content. After step 28, the user proceeds to the end of the method in step 29. If the answer to decision step 46 is “YES”, the user proceeds to step 34 where the multimedia content to E-book content association of decision step 46 is saved on the local device being used by the user. The user then proceeds to step 36, the video content to E-book content association of decision step 46 is saved on the server 12 for the system platform. After step 36 the user then proceeds to the end of method step 29.

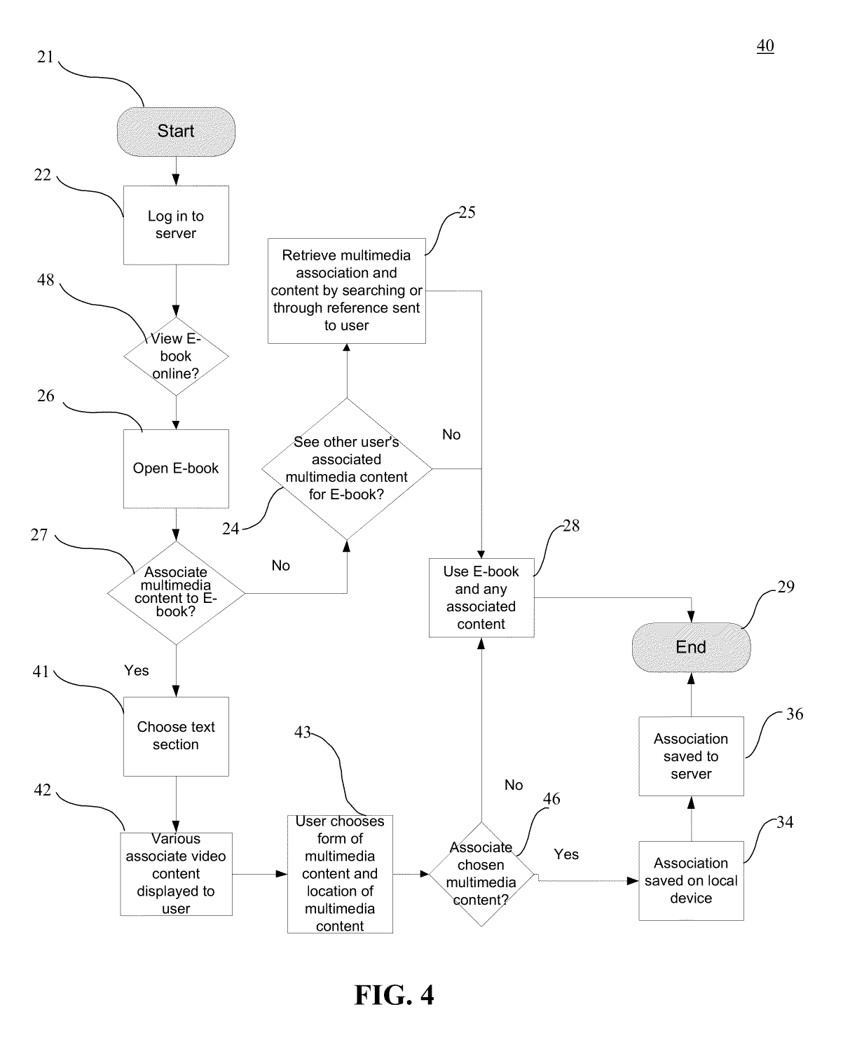

FIG. 4 illustrates a block diagram illustrating methods 40 of associating multimedia content and E-book content where both the multimedia and E-book content resides outside the device in accordance with the inventive concept. Note that where the steps in FIG. 4 are the same as in FIGS. 2 and 3, the same step numbers are used. As illustrated on FIG. 4, a user starts the method in step 20. As illustrated on FIG. 4, a user starts the method in step 21. In step 22, the user logs into the server 12 (FIG. 1) for the system platform. The user then proceeds to step 48 where an E-book is viewed online. The user next proceeds to step 26, where the user opens the E-book. After step 26, the user proceeds to decision step 27 where a user is given a choice of whether or not to associate multimedia content, such as a video, to E-book content. If the answer to decision step 27 is “NO”, the user proceeds to decision step 24 where a user is given a choice of whether or not to see other users associated multimedia content for the same E-book. If the answer to decision step 24 is “NO”, the user proceeds to step 28 in which the user uses the E-book and any associated content. After step 28, the user proceeds to the end of the method in step 29. If the answer to decision step 24 is “YES”, the user then proceeds to step 25 in which the user retrieves multimedia association and content by searching for multimedia content or by through a reference sent to the user. After step 25, the user then proceeds to step 28 in which the user uses the E-book and any associated content. After step 28, the user proceeds to the end of the method in step 29. If the answer to decision step 27 is “YES”, the user then proceeds to step 41 where a text section of interest is chosen. After step 41, the user then proceeds to step 42 where various forms of multimedia content is displayed to the user. After step 42, the user then proceeds to step 43 where the user chooses the form of multimedia content and the location of the multimedia content. After step 43, the user proceeds to decision step 46 where it is decided whether, or not to associate the multimedia content to the chosen E-book content. If the answer to decision step 46 is “NO”, the user proceeds to step 28 in which the user uses the E-book and any associated content. After step 28, the user proceeds to the end of the method in step 29. If the answer to decision step 46 is “YES”, the user proceeds to step 34 where the multimedia content to E-book content association of decision step 46 is saved on the local device being used by the user. The user then proceeds to step 36, the video content to E-book content association of decision step 46 is saved on the server 12 for the system platform. After step 36 the user then proceeds to the end of method step 29.

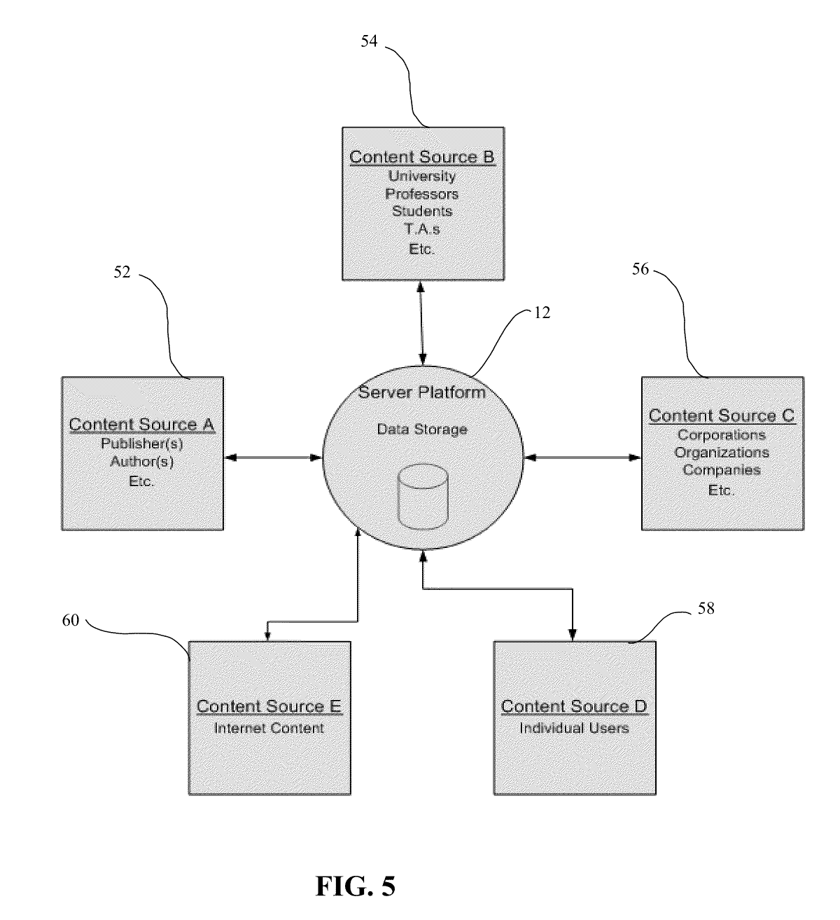

FIG. 5 illustrates a block diagram illustrating the interrelationship of and content flow between various users to the system in accordance with the inventive concept. As illustrated on FIG. 5, a server platform 12 interacts with a plurality of users, or content sources. In block 52, content source “A” from sources such as publishers and authors is exchanged with the server platform 12. In block 54, content source “B” from sources such as university professors, students and teaching assistants is exchanged with the server platform 50. In block 56, content source “C” from sources such as corporations, organizations and companies is exchanged with the server platform 50. In block 58, content source “D” from sources such as individual users is exchanged with the server platform 50. In block 60, content source “E” from sources such as the Internet is exchanged with the server platform 12.

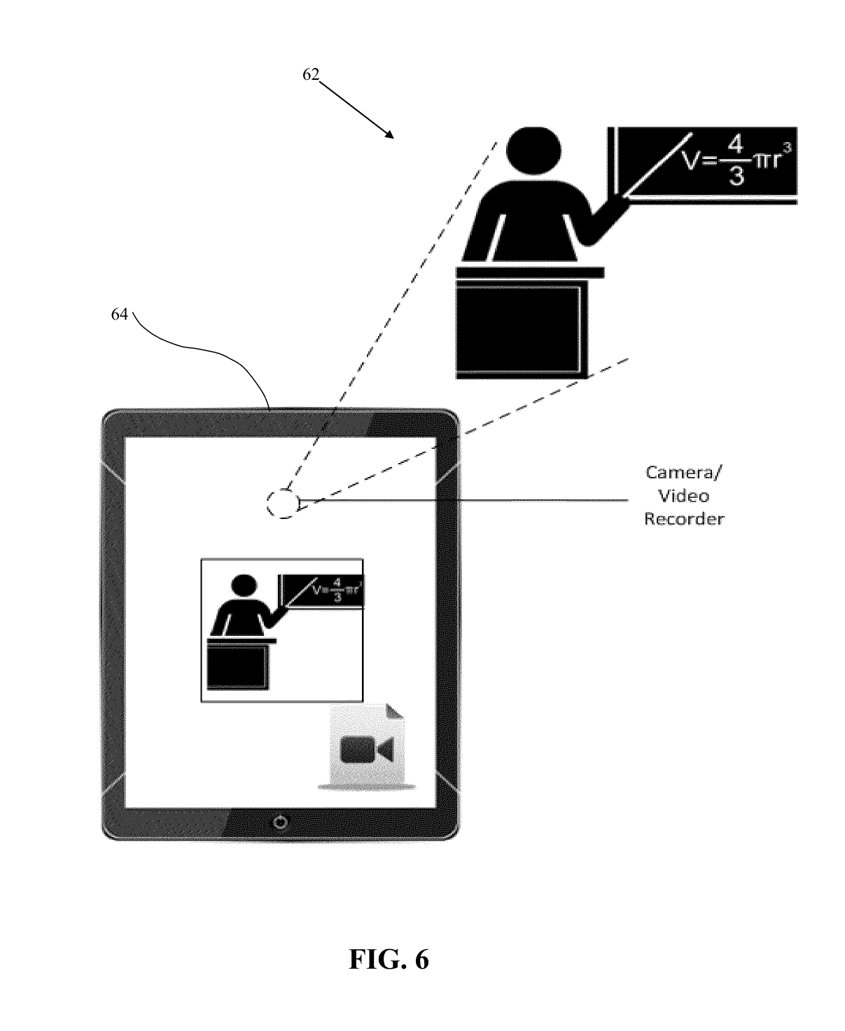

FIG. 6 illustrates a diagrammatic view of the recording of multimedia video content in accordance with the inventive concept. As illustrated on FIG. 6, a classroom lecture 62 is being recorded on a mobile device which has a video camera 64.

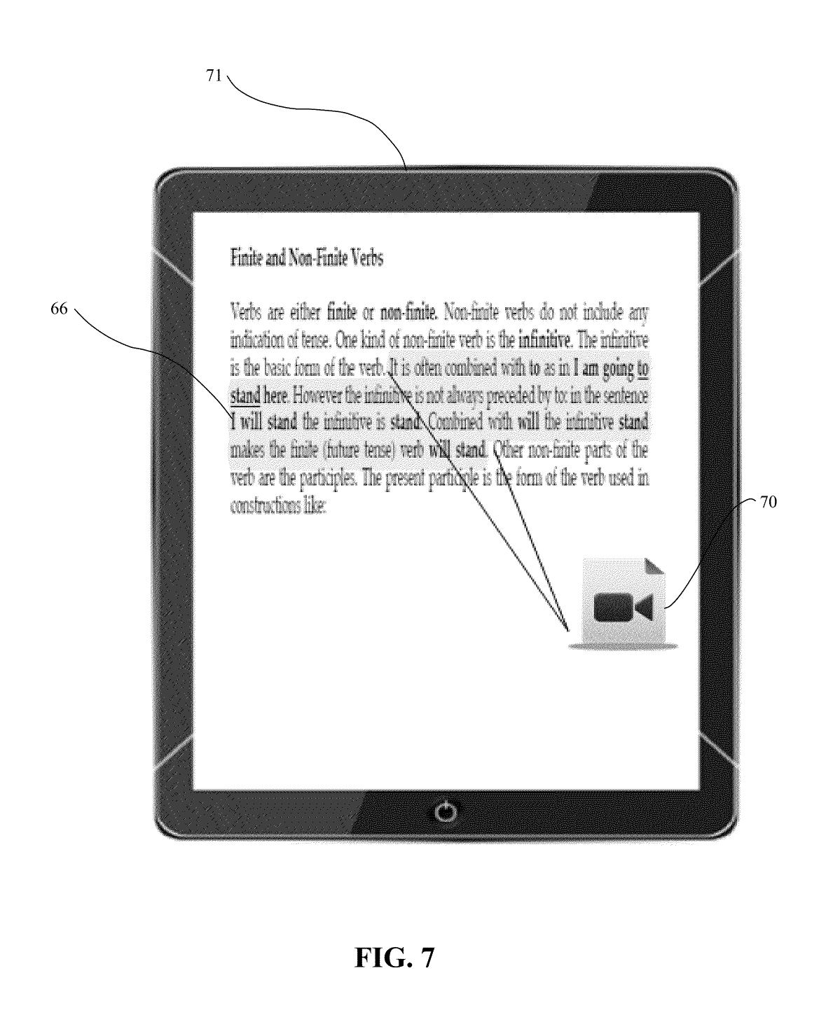

FIG. 7 illustrates a diagrammatic view illustrating the association of multimedia content to E-book content in accordance with the inventive concept. As illustrated on FIG. 7, E-book content of interest 66 is associated with multimedia content of interest. An icon 70 provides a link to the multimedia content. The icon 70 indicates the multimedia content is video content. In an implementation of the inventive concept, a separate icon would be used for each type of multimedia content, such as videos and images, for example. As illustrated on FIG. 7, a user electronically highlights E-book content of interest 66 and associates it with a link accessible by the icon 70. On FIG. 7, the multimedia content resides on the device 71. The E-book content of interest 66 may be portions of content of an E-book including a word, sentence, paragraph or a chapter.

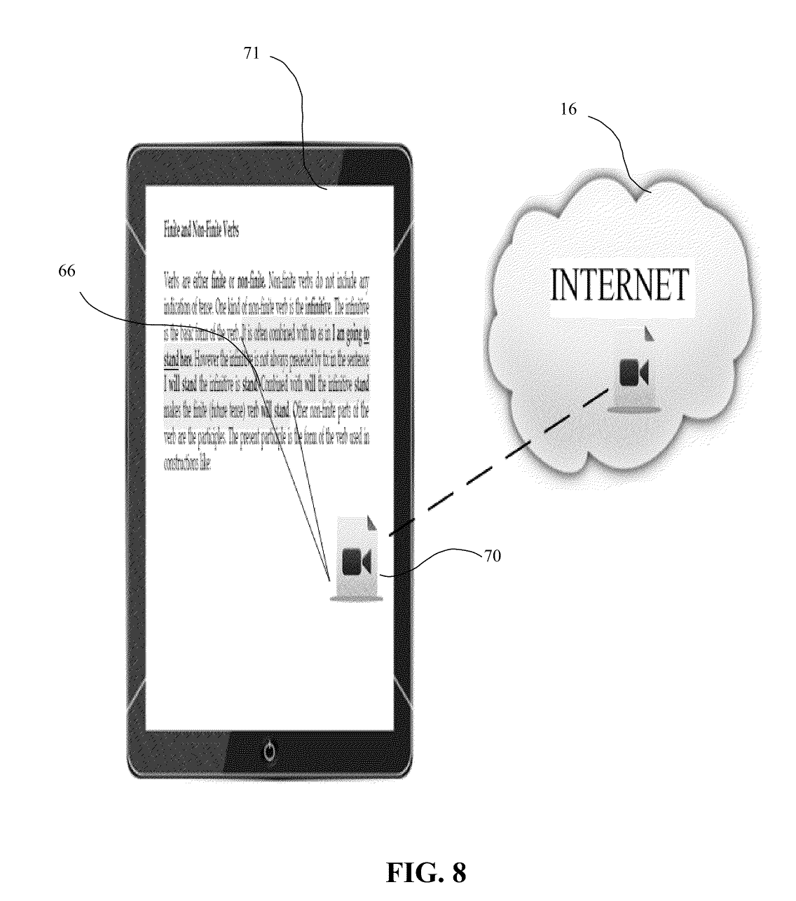

FIG. 8 illustrates associating E-book content 66 and multimedia content sourced from a source outside of the device 71, such as the Internet 16, in accordance with the inventive concept. As illustrated on FIG. 8, E-book content of interest 66 is associated with multimedia content of interest. An icon 70 provides a link to the multimedia content. The icon 70 indicates the multimedia content of interest is video content from the Internet 16.

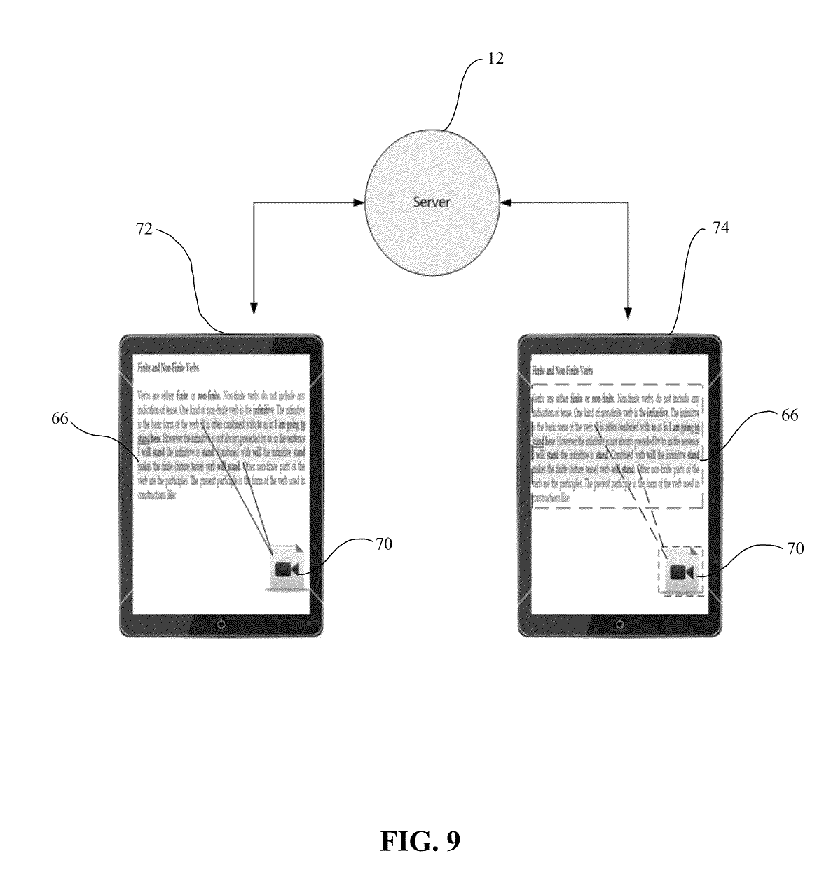

FIG. 9 illustrates the sharing of association information of multimedia content to E-book content from the server 12 to a second device 74 in accordance with the inventive concept. As illustrated on FIG. 9, the server 12 links a first device 72 used by a first user with a second device 74 used by a second user.

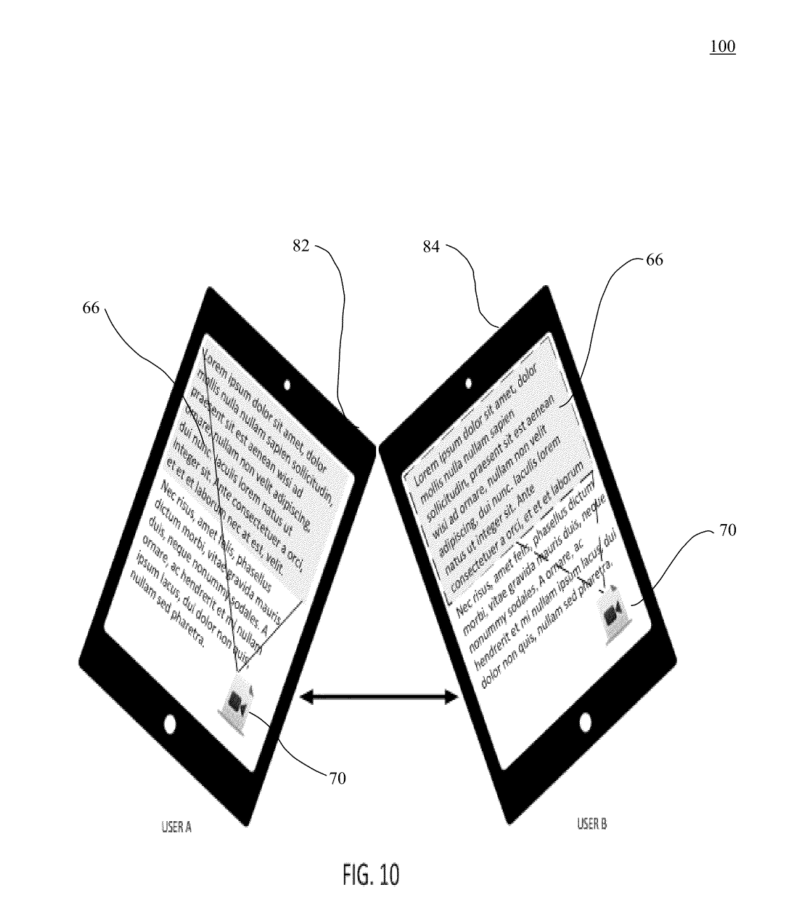

FIG. 10 is a diagrammatic view of the system 100 illustrating the sharing of association information of multimedia content to E-book content 66 between two devices without the need of an Internet connection or connection to a remote server through the use of Near Field Communication (NFC), Bluetooth, or a similar method of communication where the devices are in close proximity to each other in accordance with an inventive concept. As illustrated on FIG. 10, a first mobile device 82 is in communication with a second mobile device 84. The communication between the first mobile device 82 may be made with the second mobile device 84 without utilizing the network 11 (FIG. 1B). This communication is instead made through the use of Near Field Communication (NFC), Bluetooth, or a similar method of communication. As also illustrated on FIG. 10, a user “A” is associating E-book content of interest 66 with multimedia content of interest. When user “B” views this same E-book on the second mobile device 84, and views the page of the E-book the association of E-book content of interest 66 and multimedia content of interest 68 association from user “A” is viewable as set forth on FIG. 10. The icon 70 on the first 82 and second 84 mobile device indicates the availability and type of associated multimedia content.

FIG. 1A illustrates one system 10 of the present inventive concept of associating multimedia content and E-book content utilizing the server platform 12 and the Internet 16. The multimedia content can be user-generated, for instance, recorded by the user's tablet or smart phone, or can be supplied by others or on the Internet. Examples of multimedia content include, but are not limited to: video, images, audio, 3D renderings, holographic images and other types of multimedia content. In use of the inventive concept, as illustrated in FIG. 1A, a single, or multiple devices 14 communicate with the server platform 12 via the Internet 16. In one embodiment, the E-book may be an E-textbook and users of the system may be students, or faculty. However, the invention is not limited to just E-textbooks.

If both the multimedia content and E-book content resides on a device, the method of FIG. 2 is utilized to associate multimedia content and E-book content. If one of the multimedia content and E-book content is on the device and the other resides outside the device, the method of FIG. 3 is utilized to associate multimedia content and E-book content. If both the multimedia content and E-book content resides outside the device (i.e. in the cloud), the method of FIG. 4 is utilized to associate multimedia content and E-book content. As illustrated on FIG. 5, the inventive concept is not limited to one user, or type of user or content source, and the inventive concept may include a plurality of types of users, or content sources.

As illustrated on FIG. 6, multimedia content to be associated with E-book content may be a classroom lecture 62 recorded on a mobile device 64. In one embodiment of the invention, the classroom lecture 62 recorded on the mobile device 64 may be shared with other students in the class, or students at other schools taking a similar class which utilizes the same textbook. As illustrated on FIG. 7, E-book content of interest 66 is associated with multimedia content of interest located on the same device 14. In an embodiment, the E-book content of interest electronically selected may be determined by the Cartesian X, Y coordinates for the start and end locations of the selected text, although the invention is not limited to this method of determining content of interest. The user may change the E-book content of interest 66 at a later time by selecting different portions of E-book content. The user may also change associated multimedia content of interest at a later time by associating different multimedia content, or by editing the associated multimedia content. The multimedia content accessible on the icon 70 may be, for example, the classroom lecture 62 being recorded on FIG. 6. As illustrated on FIG. 8, E-book content of interest 66 is associated with multimedia content of interest located outside the device 71, such as a location on the Internet 16. Once a user has identified multimedia content of interest to associate with content of an E-book, a menu may appear that gives the user various options, including the option to associate video, images, audio, etc. When the user chooses one of the options, they have only to associate that content, whether that content resides on their device, such as a recorded video recorded using their tablet computer's camera, or from a 3rd party, such as all or a portion of a video from YouTube. When the association to the content is successfully made, an icon that pertains to that type of content associated to a selected text automatically appears alongside that selected text. So, for instance, a video icon automatically appears when video content is associated, an image icon automatically appears when image content is associated, etc.

As illustrated on FIG. 9, associated E-book 66 and multimedia content of interest on the first device 72 is shared with a second user on the second device 74 via the server platform 12. Once the association is made by a first user on the first device 72, the association of E-book content of interest 66 and multimedia content of interest automatically uploads to the server platform 12. In an embodiment of the invention, the E-book with the content association location and content is uploaded to the server platform 12 where it is then converted to a standard system reader format in the server platform 12 to be used by users of the system 10. If the E-book already resides on the server platform 12, only the location of the E-book content of interest 66 and the associated multimedia content of interest is uploaded. If the E-book does not yet reside on the server platform 12, the entire E-book, as well as the multimedia content and location of the content association, is uploaded to the server platform 12. The E-book and content association is then converted to the standard reader format. The E-book with this content association in the converted format may then be available to a second user with a second device 74 who is logged into the server platform 12. The availability of the E-book content of interest 66 and associated multimedia content from the first user to be available to the second user on the second device 74 depends on at least a couple of factors. First, the second user may be required to upload the same E-book to the server 12 and have the E-book converted to the standard reader format file. This requirement prevents the second user from reading the E-book of the first user without purchasing the E-book. The second user is additionally required to have permission from the first user in order to view the E-book 66 and multimedia content association made by the first user. This is due to the fact that the first user may wish to share associated E-book 66 and multimedia content with just one other user he knows, with just a small group of people, such as his classmates, or with anyone, in which case permission would not be required. A user of the system 10 has the option of viewing, or not viewing associated content. A user desiring to see associated multimedia content for E-book content of interest may be able to search a list of associated content for the E-book of interest.

FIG. 1B illustrates an overall diagrammatic view of the system 100 utilizing close proximity communication between the devices to save and share the location of the associated selected content and multimedia content without relying on a remote server in an accordance with another inventive concept. As illustrated in FIG. 1B, the first mobile device 82 is in communication with the second mobile device 84 in accordance with the inventive concept. As also illustrated in FIG. 1B, the first mobile device 82 and the second mobile device 74 are in communication with each other via close proximity communication such as through the use of Near Field Communication (NFC), Bluetooth, or a similar method of communication where the devices are in close proximity to each other and with a network 11 such as the Internet. The network 11 may also be in communication with a content provider 76. The system 100 utilizes the same association process as taught by FIGS. 7-9.

In use of system 100, a first mobile device 82 would have an association of E-book content 66 and multimedia content, such as a classroom lecture with an E-textbook which has been associated with the server platform 12. A second mobile device 84 has the same E-book associated with the server platform 12. A user of the first mobile device 82, say a student would be able, via Near Field Communications (NFC), or a similar method of close proximity communication, be able to share, say, a recorded video of a classroom lecture and the association of that lecture to multimedia content with another user with the second mobile device 84, say a classmate, provided that the other user has the same eBook which has been uploaded to the server platform and converted to the standard reader format on the server platform 12. This sharing through the use of NFC would only require that the first mobile device 82 be touching, or in close proximity with the second mobile device 84, and not require a network 11 connection. The sharing of information between the first mobile device 82 and the second mobile device 84 may also be accomplished by other types of wireless communication, such as Bluetooth, but the inventive concept is not limited to this additional technology.

While the preferred embodiments of the invention have been described above, it will be recognized and understood that various modifications can be made in the invention and the appended claims are intended to cover all such modifications which may fall within the spirit and scope of the invention.

What I claim is:

1. A method for associating E-book content with multimedia content, the method comprising:
opening an E-book file containing content on a device;
electronically selecting a portion of the content in the E-book file on the device;
electronically associating the selected content with multimedia content; and
uploading the location of the associated selected content and multimedia content to a server.

2. The method of claim 1 wherein the associated selected content may be changed after the association is made.

3. The method of claim 1 wherein the associated multimedia content may be changed after the association is made.

4. The method of claim 1 wherein the multimedia content associated with the selected E-book content is identified by an icon displayed on the device.

5. The method of claim 1 wherein a file containing the multimedia content resides on the device, and a file containing the E-book resides on the device.

6. The method of claim 1 wherein a file containing the multimedia content resides on the device, and a file containing the E-book resides outside of the device.

7. The method of claim 1 wherein a file containing the multimedia content resides outside the device and a file containing the E-book resides on the device.

8. The method of claim 1 wherein a file containing the multimedia content resides outside the device and a file containing the E-book resides outside the device.

9. The method of claim 1 wherein the file containing the E-book is obtained from the server.

10. The method of claim 1 wherein the file containing the E-book is not obtained from the server.

11. The method of claim 1 wherein a login to the server is required before the E-book is opened.

12. The method of claim 1 wherein the multimedia content is a video.

13. A method for associating E-book content with multimedia content and sharing the associated E-book content and multimedia content, the method comprising:
logging into a server from a first device;
opening an E-book file containing content on the first device;
electronically selecting a portion of the content in the E-book file on the first device;
electronically associating the selected content with multimedia content; and
uploading the associated selected content and multimedia content to the server;
wherein a file containing the location of the associated selected content and multimedia content on the first device uploaded to the server is opened on a second device.

14. The method of claim 13 wherein a file containing the location of the associated selected content and multimedia content on the first device and uploaded to the server is opened on a plurality of devices in communication with the server in addition to the second device.

15. The method of claim 13 wherein the second device is required to have access to a file with the same E-book content as the first device and the file with the same E-book content has been uploaded to the server prior to the second device opening the file containing the associated highlighted content and multimedia content uploaded to the server from the first device, and the file with the same E-book content from the second device is then converted to a standard reader format file by the server.

16. The method of claim 13 wherein the server is capable of denying permission to open a file on the second device, the file in which permission to open is denied containing the location of the associated selected content and multimedia content uploaded to the server from the first device and then converted to a standard reader format by the server.

17. The method of claim 13 wherein the multimedia content is one of video, images, audio, 3D renderings and holographic images.

18. The method of claim 13 wherein one of the file containing the E-book and a file containing the multimedia content resides outside the first device and the other of the file containing the E-book and the file containing the multimedia content resides on the device.

19. The method of claim 13 wherein the first device is capable of taking photographs and recording video.

20. A method for associating E-book content with multimedia content and sharing the associated E-book content and multimedia content, the method comprising:
logging into a server from a first device;
opening an E-book file containing content on the first device;
electronically selecting a portion of the content in the E-book file on the first device;
electronically associating the selected content with multimedia content; and
uploading the location of the associated selected content and multimedia content to the server.
wherein a file containing the location of the associated selected content and multimedia content on the first device is capable of being shared to another device through one of Near Field Communication, Bluetooth, and an app which resides on one of or both of the first device and the other device and which allows the transferring of the file containing the associated highlighted content and multimedia content from the first device to the other device by touching the first device to the other device or by locating the first device in close proximity to the other device.
